(19) United States
(12) Patent Application Publication
(10) Pub. No.: US 2019/0225473 A1
(43) Pub. Date: Jul. 25, 2019

(54) ASEPTIC TREATMENT APPARATUS AND ACTUATION DEVICE HAVING A ROTATING AND LIFTING MOVEMENT

(71) Applicant: KHS GmbH, Dortmund (DE)

(72) Inventors: Alexander Danelski, Bad Kreuznach (DE); Thomas Niehr, Bad Münster am Stein Ebernburg (DE)

(21) Appl. No.: 16/314,500

(22) PCT Filed: May 24, 2017
(86) PCT No.: PCT/EP2017/062679

§ 371 Date: Dec. 31, 2018

(30) Foreign Application Priority Data
Aug. 2, 2016 (DE) 10 2016 114 273.5

(51) Int. Cl. B67C 3/22

(52) U.S. Cl. CPC B67C 3/22; F16J 3/041

(57) ABSTRACT

A flexible seal that couples to a rod that translates and also rotates around an axis and that rotates around said axis, wherein said flexible seal has first and second folding-sections. The first folding-section has folds that are oriented to wind around the axis when said rod rotates. The second folding-section has folds that are oriented to cause a change the second folding-section's length in response to translation of said rod.

### RELATED APPLICATIONS

This is the national stage of international application PCT/EP2017/062679, filed on May 24, 2017, which claims the benefit of the Aug. 2, 2016 priority date of German application DE 10 2016 114 273.5, the contents of which are incorporated herein by reference.

### FIELD OF INVENTION

The invention relates to a treatment apparatus for the treatment of containers inside a clean room and to an actuation device for generating a rotary-lifting movement.

### BACKGROUND

Within the bottling industry, certain procedures are best carried out under aseptic conditions. These procedures include blowing and molding a container from a thermoplastic, filling it, and closing it.

In treatment machines for carrying out these operations, there often exists a moving tool that extends into an aseptic volume through some type of seal. This tool is often called upon to translate and to rotate. As a result, the seal must be made to accommodate this movement.

### SUMMARY

An object of the invention is to provide a way to seal an opening into a clean room in a simple way while accommodating translation and rotation of an actuating element.

In one aspect, the invention features a flexible seal that aseptically seals a feed-through opening into a clean room and that tightly surrounds a rod-like actuating element. The flexible seal is folded in such a way that it accommodates both a mechanical rotating movement as well as a mechanical lifting movement of the rod-like actuating element. With the bellows-like sealing element configured according to the invention, a sealing of the clean room which is simple in comparison with the prior art is achieved in the area of the feed-through opening. This seals both the clean room aseptically tight against the atmosphere prevailing outside the clean room, as well as allows for a rotating and simultaneous lifting and lowering movement of the actuating element.

In some embodiments, the bellows-like sealing element comprises at least one folding section that can be moved between a non-actuated position of rest and an actuated working position which in the non-actuated position of rest exhibits a folding section extending in the longitudinal direction of the bellows-like sealing element.

In some embodiments, the first folding-section in the non-actuated starting position has a fold that is preliminarily wound around a mid-axis along the longitudinal direction of the bellows-like sealing element.

In other embodiments, the first folding-section in the actuated position has a fold that is wound in around a mid-axis along the longitudinal direction of the bellows-like sealing element such that the fold of the first folding-section is configured such as to accommodate both a mechanical rotating movement as well as a mechanical lifting movement of the rod-like actuating element.

In yet other embodiments, the first folding-section is configured such as to be turned from the non-actuated position of rest into the actuated working position through 90° to 180°.

Embodiments also include those in which the bellows-like sealing element comprises at least one second folding-section that can be moved between a non-actuated position of rest and an actuated working position, which, in both the non-actuated position of rest as well as in the actuated working position, has a fold running transverse to the longitudinal extension of the second folding-section and thus accommodates a mechanical lifting movement of the rod-like actuating element.

Among these are embodiments in which the second folding-section for accommodating the mechanical lifting movement is configured in leporello form.

In some embodiments, the second folding-section connects along the mid-axis to the first folding-section.

In yet other embodiments, the first folding-section can be provided between two second folding-sections, which on both sides of the first folding-section connect along the mid-axis directly to the first folding-section.

Further embodiments include a rotation securing device that is configured such as to detach the first folding-section from the second folding-section and that is folded transversely to the drive element, both in its non-actuated position as well as in its actuated working position, to prevent an unwanted rotational movement about the mid-axis. In other words, a dynamic rotation or winding of the first folding-section to cause a rotational movement of a treatment element is decoupled from the second folding-section such that no torsion forces are introduced into this second folding-section.

As used herein, “essentially” refers to changes that are of no functional significance. Depending on the context, “essentially” refers to deviations from a exact value of five percent or in some cases ten percent.

In the present context, “aseptic” and “sterile” are synonyms and refer to the achievement of a predetermined hygienic requirement. In addition, hereafter “clean room” is always to be understood as a sterile and/or aseptic clean room.

Further embodiments, advantages, and possible applications of the invention derive from the following description of exemplary embodiments and from the figures. In this situation, all the features described and/or represented graphically are in principle the object of the invention, taken alone or in any desired combination, in the claims or in reference made to them. The contents of the claims are also deemed to be a constituent part of the description.

### BRIEF DESCRIPTION OF THE FIGURES

These and other features of the invention will be apparent from the following detailed description and the accompanying figures, in which:

FIG. 1 shows a side view of an aseptic treatment-device.

FIG. 2 shows a section through a clean room of the treatment device shown in FIG. 1;

FIG. 3a is a side view of a flexible seal shown in FIG. 2;

FIG. 3b is a section of a plane across the flexible seal of FIG. 3a;

FIG. 4a shows an anti-rotation mechanism in the flexible seal shown in FIG. 2.

FIG. 4b shows a cross-section of the anti-rotation mechanism shown in FIG. 2.

FIG. 5a shows an alternative embodiment of the flexible seal shown in FIG. 3a;

FIG. 5b shows a cross-section through the flexible seal shown in FIG. 5a; and

FIG. 6 shows an alternative embodiment of the flexible seal shown in FIG. 2.

### DETAILED DESCRIPTION

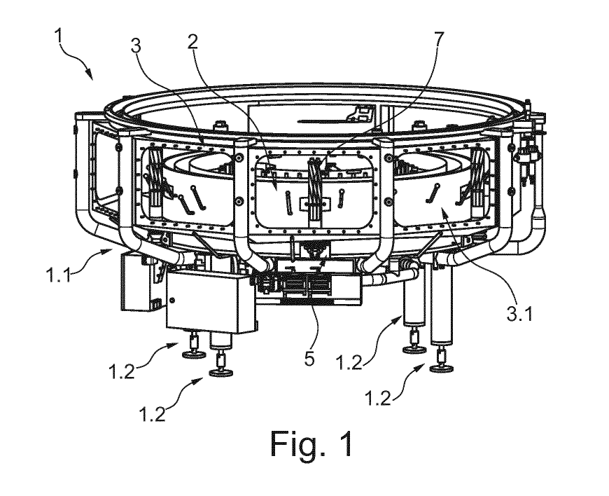

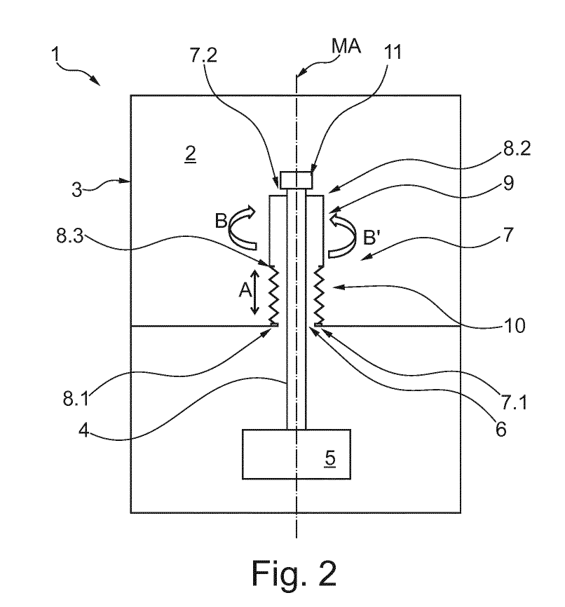

FIG. 1 shows an aseptic-treatment device 1 for producing and/or treating containers that are inside a clean room 2. To avoid excessive complexity, only those components that are necessary for understanding the invention are shown in FIGS. 1 and 2. The various modules and components that make up the treatment device 1 are arranged on supports 1.2 that couple to a machine frame 1.1

The aseptic-treatment device 1 can take several forms. In some embodiments, the aseptic-treatment device 1 is a blow-molding machine that is used for molding containers from a thermoplastic. In other embodiments, the aseptic-treatment device 1 is an aseptic filling-machine for filling containers with liquid filling-material. In yet other embodiments, the aseptic-treatment device 1 is a closing machine for closing screw caps or other closures onto containers. Such treatment devices are suitable for use in the beverage industry.

The aseptic-treatment device 1 includes a clean room 2 arranged in an aseptically-closeable housing 3 for treatment of containers. In some embodiments, the aseptically-closeable housing 3 includes plural wall sections that close against each other to form the clean room 2. In other embodiments, the aseptically-closeable housing 3 includes windows 3. In the figures, a cover that would normally cover the aseptically-closeable housing 3 has been omitted to reveal the what lies within. Some embodiments feature plural clean rooms 2 that are separated from each other. In such embodiments, each clean room 2 is aseptically closeable by its own independent cover.

Referring now to FIG. 2, a rod 4 extends along a mid-axis MA through an opening 6 in a partition 2.1 in the housing 3. The rod 4 can be a shaft, a ram, or a lifting rod. It can be hollow or filled with a material, such as a metallic material. The opening 6 has an inner diameter slightly larger than the outer diameter of the rod 4 so that a small gap extends between them. This permits the rod 4 to move freely.

An actuator 5 coupled to the rod 4 transfers a torque that rotates the rod and a force that results in lifting and lowering the rod 4. As a result, the rod 4 is able to freely rotate clockwise and counter clockwise B, B′ and to translate vertically up or down A.

In the illustrated embodiment, the actuator 5 is mechanically force-coupled to a first end of the rod 4 such that the torque and the force are transmitted directly to the rod 4. However, in an alternative embodiment, there exists a reversing gear between the actuator 5 and the rod 4 that converts the actuator's drive movement into a form suitable to rotate or translate the rod 4 and that transfers that movement to the rod 4.

In FIGS. 1 and 2, the actuator 5 lies beneath the clean room 2. However, it is also possible to place the actuator 5 above or to one side of the clean room 5. It is important, however, that the actuator 5 be outside the clean room 2.

A flexible seal 7 surrounding the rod 4 aseptically seal off the housing 3 of the clean room 2. The flexible seal 7 is one that accommodates the rod's translation A and rotation B, 3′. In the illustrated embodiment, at least a portion of the flexible seal 7 is a bellows. First and second free-faces 7.1, 7.2 lie at opposite ends thereof. The flexible seal 7 includes first and second folding-section 9, 10, each of which transitions between a resting position AR and an actuated position AP independently of each other.

In the area of the first free-face 7.1, a first ring 8.1 forms an annular base that seals tightly against the housing 3 around the opening 6 on that side of the housing 3 that faces the clean room 2. The rod 4 extends through the first ring 8.1 as it passes through the opening 6 along the mid-axis MA.

In the area of the second free face 7.2, a second ring 8.2 accommodates the rod 4 and forms a seal around the rod 4, thereby enabling a second end of the rod 4 to extend into the clean room 2 itself.

Between the first and second rings 8.1, 8.2, the flexible seal 7 deforms in a way that accommodates the rod's rotation and translation. To avoid having the first and second rings 8.1, 8.2 come loose as the flexible seal 7 deforms during the rod's translation and rotation, it is useful to securely connect the first ring 8.1 to the housing and to securely connect the second ring 8.2 to the rod 4. Embodiments include those in which the secure connection occurs as a result of adhesive bonding, soldering, welding, or screwing.

A third ring 8.3 lies between the first and second folding-sections 9, 10. The first folding-section 9 extends between the second ring 8.2 and the third ring 8.3. The second folding-section 10 extends between the third ring 8.3 and the first ring 8.1.

A first side surface of the third ring section 8.3 seals tightly against the first folding-section 9 and a second side surface of the third ring 8.3 seals tightly against the second folding-section 10. The first and second side surfaces of the third ring 8.3 are opposite each other such that normal vectors to those faces are parallel to the mid-axis MA but oppositely directed. Embodiments include those in which the seal between the third ring 8.3 is formed by adhesive bonding, soldering, welding, or screwing.

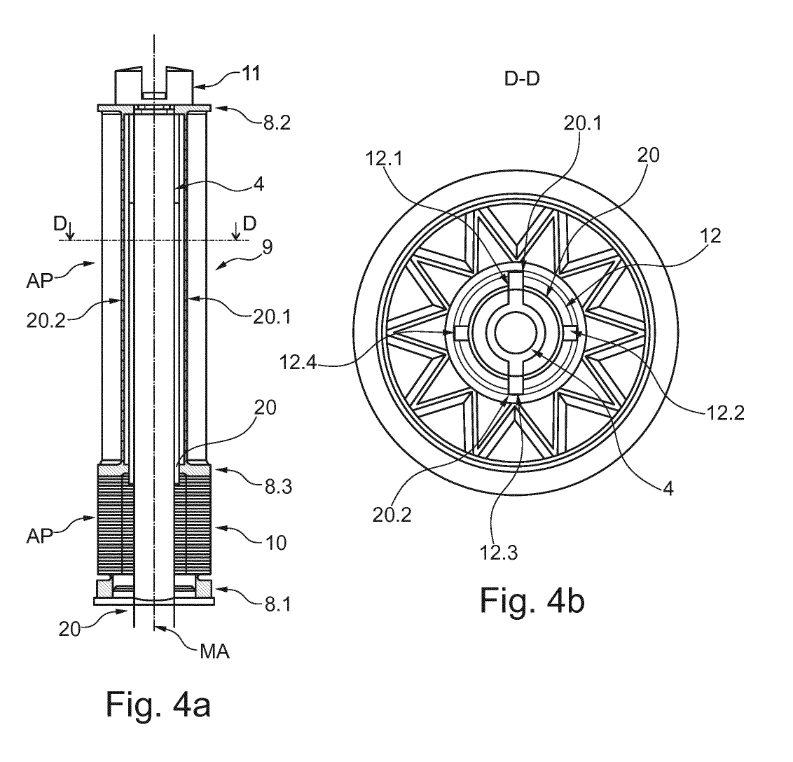

The third ring 8.3 separates the rod's movements by having an anti-rotation arrangement 20 that is explained in greater detail in connection with FIGS. 4a and 4b.

In alternative embodiments, the flexible seal 7 is monolithic and therefore has no clearly defined third ring section. In yet other embodiments, the flexible seal 7 has folding sections in addition to the first and second folding-sections 9, 10 and additional intermediate rings in addition to the third ring 8.3.

A treatment element 11 is securely mounted at the second end of the rod 4 inside the clean room 2. The nature of the treatment element 11 depends on the particular type of aseptic-treatment device 1. Examples of a treatment element 11 include a closing head for fixing screw caps or closures onto containers or a CIP cap for use during CIP cleaning. As a result of being coupled to the rod 4, the treatment element 11 can be made to translate and rotate.

Although FIG. 2 shows the second ring 8.2 as being below the treatment element 11, there are also embodiments in which the second ring 8.2 extends up to the treatment 11, in which case there exists a contact-tight coupling between the second ring 8.2 and the treatment element 11. In some cases, the treatment element 11 is screwed into the rod 4. This maintains an aseptic seal between the rod 4 and the treatment element 11.

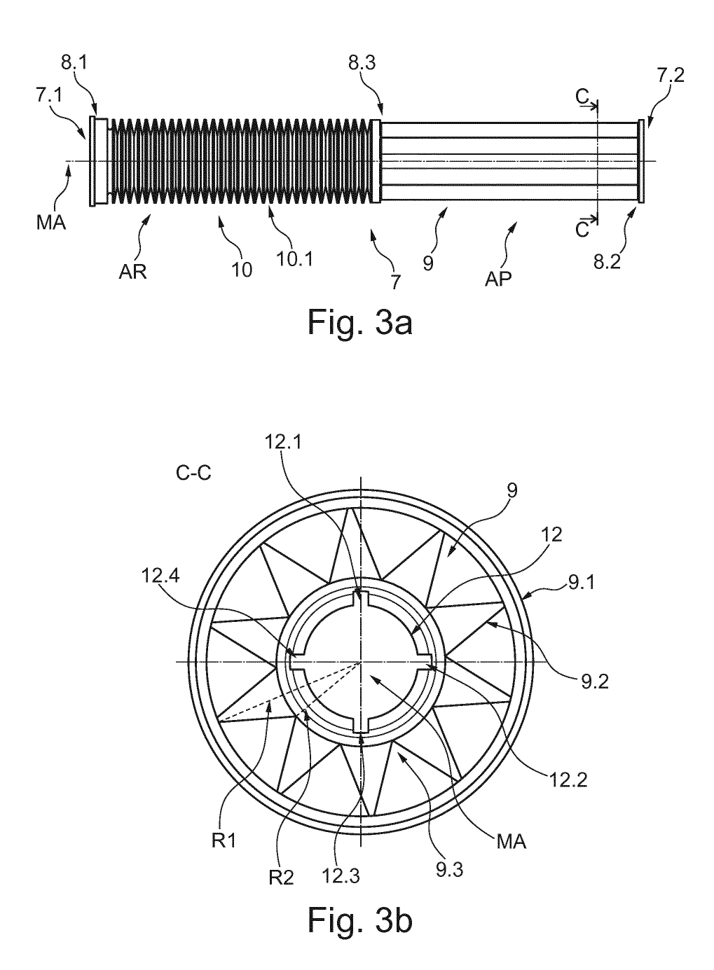

As can be seen in FIG. 3a, the first folding-section 9 has axial folds that accommodate twisting and the second folding-section 10 has circumferential folds 10.1 that accommodate compression and expansion.

As shown in FIG. 3b, each axial fold has an outer edge 9.1 located at a first radius R1 as measured from the mid-axis MA and an inner edge 9.3 located at a radius R2 as measured from the mid-axis MA. In the rest position shown in FIG. 3b, the outer edges 9.1 and the inner edges 9.3 are parallel to the mid-axis MA. A pair of flanks 9.2 connects each inner edge 9.3 to two adjacent outer edges 9.1. This results in a star-shaped cross-section in which the outer edges 9.1 form the tips of the star and the inner edges 9.3 form the grooves between the tips.

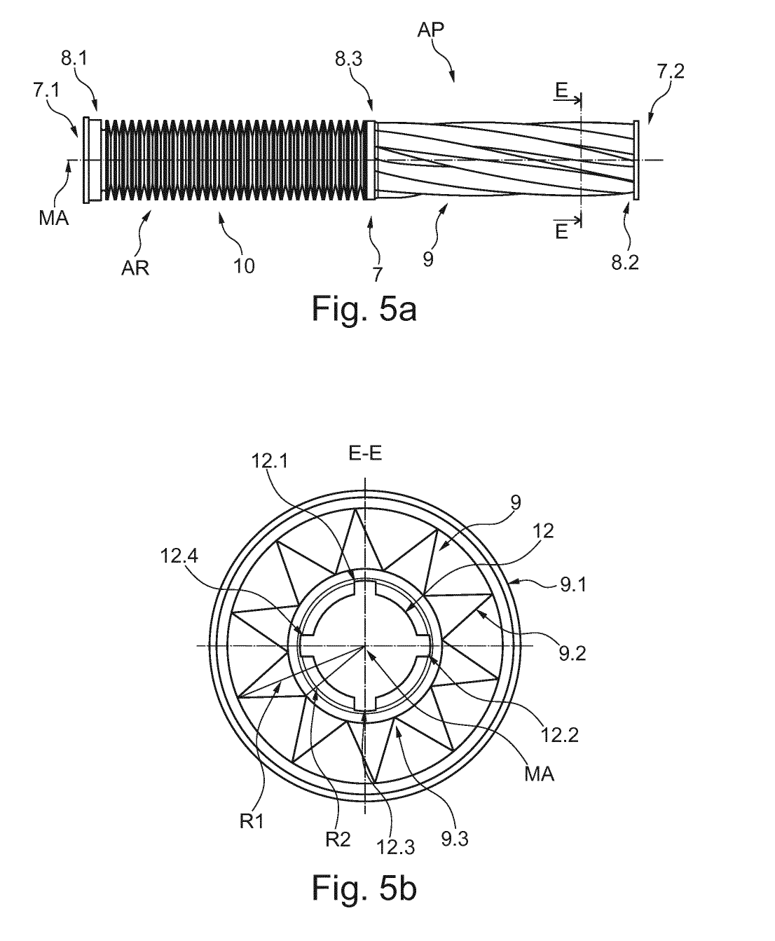

When the rod 4 twists, the inner and outer edges 9.1, 9.3 will no longer be parallel to the mid-axis MA. In addition, they will move by different amounts since they are at different radii. Since the flanks 9.2 connect the inner and outer edges 9.1, 9.3, they too move by varying amounts. Because one end of the first folding-section 9 is anchored and the other end rotates, the circumferential displacement will be a function of distance from the anchored end. This causes the inner and outer edges 9.1, 9.3 to twist into their active position as shown in FIG. 5a. As a result, the flexible seal 7 is able to accommodate the rod's rotation. In some embodiments, the inner and outer edges 9.1, 9.3 of the axial folds twist to accommodate a ninety-degree rotation. In others, the inner and outer edges 9.1, 9.3 of the axial folds twist to accommodate a one-hundred eighty degree rotation.

The circumferential folds 10.1 define a leporello that changes length in response to the rod's translation. Each circumferential fold 10.1 has inner and outer edges that move together or further apart in response to the rod's translation. This enables the flexible seal 7 to accommodate the rod's translation.

As a result of the cooperation between the circumferential folds 10.1 and the axial folds, the flexible seal 7 accommodates both translation and rotation of the rod 4.

In a preferred embodiment, either the first or second folding-sections 9, 10 or both are made of an elastically deformable material. Suitable choices include silicone and TEFLON(R). It is also preferable that the material be one that is chemically resistant so that it can be more easily cleaned and sterilized.

It is useful to decouple the rotation of the first folding-section 9 from the translation of the second folding-section 10. To achieve this, an anti-rotation mechanism 20 engages a tubular feed-through section 12 for the rod 4. This tubular feed-through section 12 extends axially and is concentric with the mid-axis MA. Extending axially along the tubular feed-through section 12 are four grooves 12.1-12.4 separated from each other by equal angles with the first and third grooves 12.1, 12.3 diametrically opposed and the second and fourth grooves 12.2, 12.4 also diametrically opposed. The first and third grooves 12.1, 12.3 engage corresponding structures in the anti-rotation mechanism 20, which is explained in detail in connection with FIGS. 4a and 4b. The second and fourth cut-outs 12.2, 12.4 provide a pathway for air that is displaced during the rod's movement.

FIGS. 4a and 4b show an embodiment that features an anti-rotation mechanism 20 that interacts with the third ring 8.3.

The anti-rotation mechanism 20 features a sleeve that surrounds a section of the rod 4 within the folding seal 7. The anti-rotation mechanism 20 remains fixed to the actuator 5 or to the housing 3 and the rod 4 rotates and translates relative to the anti-rotation mechanism 20.

The sleeve has one end secured to the partition 2.1 and two opposed engagement sections 20.1, 20.2, best seen in FIG. 4a. In some embodiments, these take the form of matched splines or feather keys that have been secured in a suitable manner, such as by having been welded or soldered. In such cases, the sleeve includes a flange that serves as a passage for the rod 4 and that provides a way to secure it to the partition 2.1.

These engagement sections 20.1, 20.2 extend axially along the flexible seal 7 with their lengths matching the extent to which the second folding-section 10 moves between its rest position and actuated position. As can be seen in FIG. 4b, the first and third grooves 12.1, 12.3 engage these engagement sections 20.1, 20.2.

FIG. 4a shows the second folding-section 10 with its circumferential folds fully folded. In this configuration, the third ring 8.3 makes its closes approach to the first ring 8.1. It is apparent that even in this position, the engagement sections 20.1, 20.2 of the anti-rotation mechanism 20 are long enough so that the third ring 8.3 continues to engage them. These engagement sections 20.1, 20.2 extend far enough towards the second ring 8.2 so that even when the second folding-section 10 is fully extended, they are still able to engage the third ring 8.3.

If, during operation, the actuator 5 causes the rod 4 to rotate, the first folding-section 9 rotates in response. However, the anti-rotation mechanism 20 prevents the second folding-section 10 from also rotating.

An alternative embodiment has the second ring 8.2 contacting the partition 2.1 and the first ring 8.1 contacting the treatment element 11. In this embodiment, the second folding-section 10 couples to the treatment element 11. In this embodiment, the second folding-section 10 rotates as a whole with the rod 4. The anti-rotation mechanism 20 is thus provided between the rod 4 and the feed-through section's first and third grooves 12.1, 12.3.

In the embodiment shown in FIG. 3a, the inner and outer edges 9.1, 9.3 of the axial folds were oriented parallel to the mid-axis MA when the first folding-section 9 was in its resting position. However, in some embodiments, these inner and outer edges 9.1, 9.3 are pre-wound so that they already form helices in the resting position, as shown in FIGS. 5a and 5b. A suitable angle for the inner and outer edges 9.1, 9.3 is between five degrees and thirty degrees of arc.

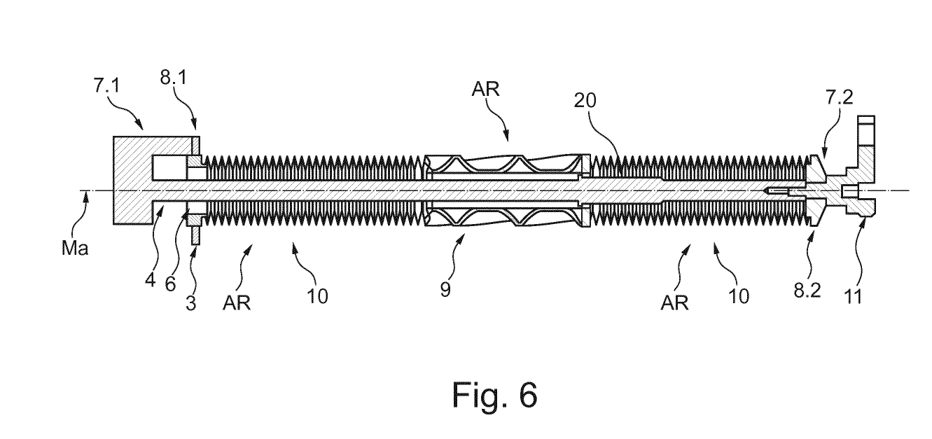

Some embodiments enlarge the range of translation by having two instances of the second folding-section 10 in series, as shown in FIG. 6. Preferably, the first folding-section 9 is between the two instances of the second folding-section 10.

In the embodiment shown in FIG. 6, it is possible to use a spline or feather key as an anti-rotation mechanism 20 that transfers torque from the rod 4 to the first folding-section 9, thus protecting the first folding-sections 10 from having to carry out any rotation.

Having described the invention and a preferred embodiment thereof, what is claimed as new and secured by letters patent is:

1-9. (cancelled)

10. An apparatus comprising a flexible seal that couples to a rod that translates around an axis and that rotates around said axis, wherein said flexible seal comprises a first folding-section and a second folding-section, wherein said first folding-section comprises folds that are oriented to wind around said axis when said rod rotates, and wherein said second folding-section comprises folds that are oriented to cause a change in length of said second folding-section in response to translation of said rod.

11. The apparatus of claim 10, wherein said first folding-section comprises folds wound around a longitudinal direction of said flexible seal such that said fold accommodates both translation and rotation of said rod, wherein said folds have fold edges that wind around said axis when said rod rotates in a first direction and unwind around said axis when said rod rotates in a second direction opposite said first direction.

12. The apparatus of claim 10, wherein said folds of said first folding-section are configured to wind between ninety degrees and one hundred eighty degrees during transition of said first folding-section from a resting position to a working position.

13. The apparatus of claim 10, wherein said first folding-section comprises a fold edge that has a first point and a second point, wherein said first point is at a first end of said first folding-section, wherein said second point is at a second end of said first folding-section, wherein, in response to rotation of said rod said second point rotates relative to said first point by an angle, wherein said angle is between 90 degrees and 180 degrees.

14. The apparatus of claim 10, wherein said second flexible section has folds that run transversely to said axis, wherein said flexible section transitions between a working position and a resting position, wherein said folds fold and unfold in response to translation of said rod.

15. The apparatus of claim 10, wherein said second folding-section comprises a leporello.

16. The apparatus of claim 10, wherein said first folding-section and said second folding-section connect along said axis.

17. The apparatus of claim 10, further comprising a third folding-section, wherein said third folding-section is equivalent to said second folding-section, wherein said first folding-section is disposed between said second folding-section and said third folding-section, wherein said second folding-section connects to a first end of said first folding-section and said third folding-section connects to a second end of said first folding-section.

18. The apparatus of claim 10, further comprising an anti-rotation mechanism that is configured to prevent transmission of torque to said second folding-section.

19. The apparatus of claim 10, wherein said second folding-section comprises a bellows.

20. The apparatus of claim 10, further comprising an aseptic-treatment machine that comprises an aseptic clean-room arranged in a housing and an actuator outside said clean room that causes said rod to move, wherein said rod passes through a hole that passes through a wall of said clean room and couples to at treatment element inside said clean room, and wherein said flexible seal isolates said rod from said clean room.

21. The apparatus of claim 10, wherein said second folding-section is configured to change length to an extent equal to an extent to which said rod translates.

22. The apparatus of claim 10, wherein said second folding-section is configured to avoid rotation when said rod rotates.

23. The apparatus of claim 10, wherein said first folding-element comprises an outer edge located at a first radius and an inner edge located at a second radius that is less than said first radius, and flanks that connect said inner edge to adjacent outer edges, wherein, in operation, said second radius changes.

24. The apparatus of claim 10, wherein, when said first folding-section is in a resting position, said folds of said first folding-section extend along said axis.

25. The apparatus of claim 10, wherein, when said first folding-section is in a resting position, said folds of said first folding-section are pre-wound around said axis.

26. The apparatus of claim 20, wherein said treatment element is connected to said second folding-section.

27. The apparatus of claim 10, further comprising a tubule feed-through section that is concentric with said axis, wherein said feed-through comprises grooves.

28. The apparatus of claim 10, wherein a first set of said grooves engages engagement sections of an anti-rotation mechanism, wherein said engagement sections extend parallel to said axis and have lengths that are sufficient so that said engagement sections engage said grooves regardless of an extent to which said rod has translated.

29. The apparatus of claim 10, wherein a second set of said grooves remains empty.
